(19) United States
(12) Patent Application Publication
(10) Pub. No.: US 2020/0239279 A1
(43) Pub. Date: Jul. 30, 2020

(54) ELEVATOR PROVIDED WITH AN ARRANGEMENT FOR MAKING AN OPENING THROUGH THE ROOF OF AN ELEVATOR CAR

(71) Applicant: KONE Corporation, Helsinki (FI)

(72) Inventors: Markku HAAPANIEMI, Helsinki (FI); Matti RÄSÄNEN, Helsinki (FI); Janne MIKKONEN, Helsinki (FI); Ari KATTAINEN, Helsinki (FI); Esko AULANKO, Helsinki (FI)

(73) Assignee: KONE Corporation, Helsinki (FI)

(21) Appl. No.: 16/850,617

(22) Filed: Apr. 16, 2020

Related U.S. Application Data
(63) Continuation of application No. PCT/FI2017/050860, filed on Dec. 4, 2017.

(51) Int. Cl. B66B 5/02; B66B 11/02

(52) U.S. Cl. CPC B66B 5/027; B66B 11/0226

(57) ABSTRACT

An elevator provided with an arrangement for making an opening through the roof of an elevator car. The arrangement includes a marking on the roof for marking a portion, which is arranged to be cut off from the roof to form an opening to the roof.

The present invention relates to an elevator provided with an arrangement for making an opening through the roof of an elevator car as defined in the preamble of claim 1.

According to international regulations, an elevator car must comprise an escape means for cases of emergency. In some kinds of elevators, the escape means must comprise a hatch or corresponding fitted on the roof of the elevator car. However, rescue operations through the roof of the elevator car are extremely rare. One example of an elevator comprising this kind of roof hatch is disclosed in European patent publication No. EP1988049 (A1). Problem of these kinds of solutions is that the escape hatch increases the costs of the elevator and requires additional space on the roof of the elevator car.

The objective of the present invention is to eliminate drawbacks of the prior art technology and to achieve an inexpensive and space-saving arrangement for making an opening through the roof of an elevator car and for making it possible to escape from the elevator car through the roof of the car. To achieve the objective mentioned above, the elevator according to the invention does not comprise a separate hatch on the roof of the elevator car. Because of that, the costs of the elevator are lower and space is saved on the roof of the car.

The elevator according to the invention is characterized by what is disclosed in the characterization part of claim 1. Other embodiments of the invention are characterized by what is disclosed in the other claims.

The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise, the different details presented in connection with each embodiment can also be applied in other embodiments. In addition, it can be stated that at least some of the subordinate claims can, in at least some situations, be deemed to be inventive in their own right.

In order to achieve the objectives mentioned above, the present invention provides an elevator provided with an arrangement for making an opening through the roof of an elevator car. Advantageously, the arrangement comprises a marking on the roof of the elevator car for marking a portion, which is arranged to be cut off from the roof to form an opening to the roof.

Preferably, the marking of the portion is on the area of the roof of the elevator car which area is free from elements that would make the cutting off the portion unsafe or slow or otherwise difficult. For example, the area of the roof mentioned above is free from reinforcements, electric cables or other important parts or components.

The car roof structure could advantageous be made so that cutting off could be carried out easy, preferably along a marking line of the marking, for example using a box cutter or other suitable knife. Of course the area which is intended to cut off should be capable to carry the loads which may directed to it in normal use or in maintenance of the elevator.

One advantage of the solution according to the invention is that the elevator does not need a separate hatch on the roof of the elevator car, hence the arrangement lowers the costs of the elevator and saves space on the roof of the elevator car. A further advantage of the invention is that, in a case of emergency, saving passengers through the roof of the elevator car is safer for the passengers and the rescuers compared to elevator cars having a separate roof hatch. Yet a further advantage of the invention is that it is easy and inexpensive to implement. Yet a further advantage of the invention is that the same car structure can be used also for elevator cars where no hatch or opening on the roof is needed. This makes production simpler and reduces costs. Naturally, in case the car roof balustrade was not good enough protection against falling from the car roof, the passengers and the rescuers should wear suitable safety harnesses during the rescue.

In the following, the invention will be described in detail by the aid of one example embodiment by referring to the attached simplified and diagrammatic drawings, wherein

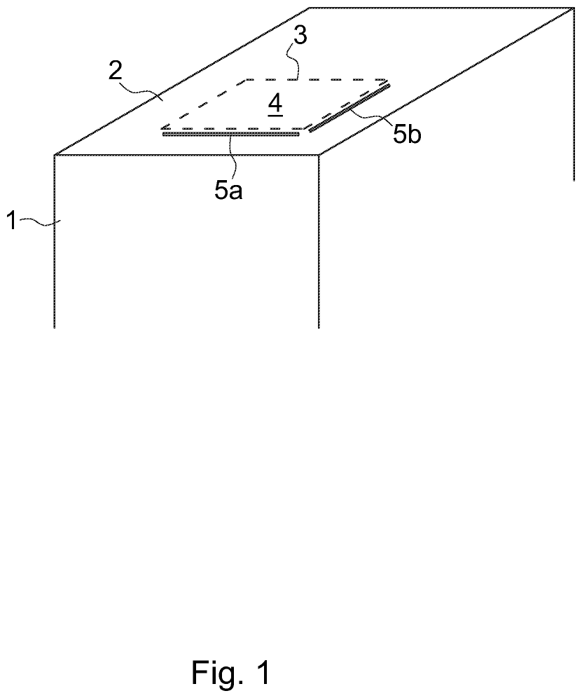

FIG. 1 presents in a simplified and diagrammatic oblique view an upper part of an elevator car where the arrangement according to the invention is applied,

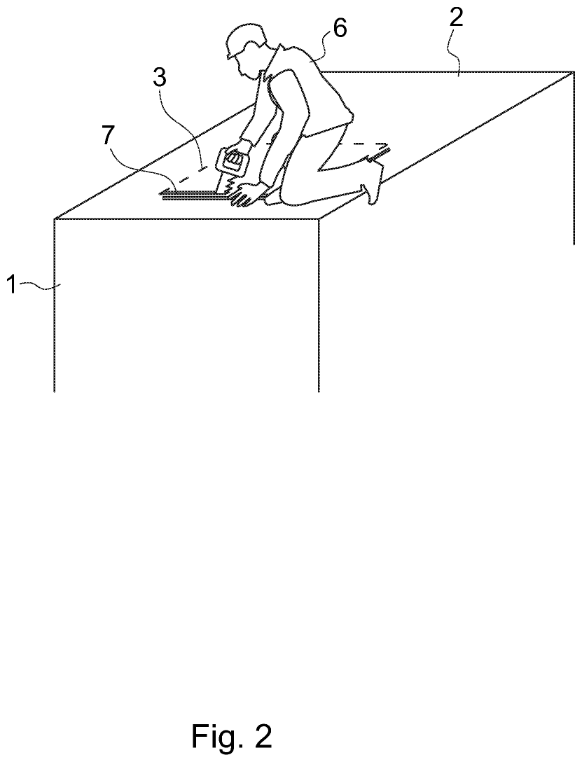

FIG. 2 presents a situation of emergency where a rescuer is making a rescue opening to the roof of the elevator car, and

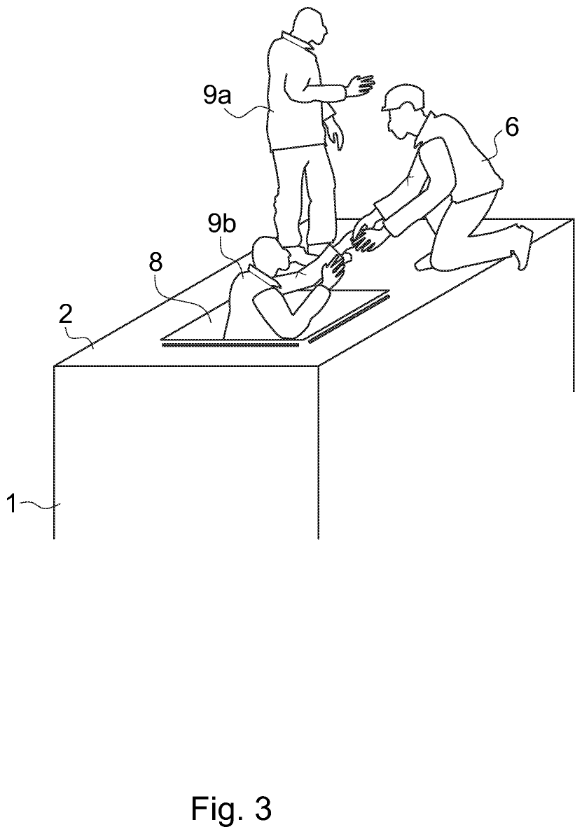

FIG. 3 presents a situation where passengers are being rescued from the elevator car through the said opening.

FIG. 1 presents in simplified and diagrammatic oblique view an upper part of an elevator car 1 where the arrangement according to the invention is applied. The outside surface of the roof 2 of the elevator car 1 is equipped with a marking 3, which is arranged to mark a portion 4 that is arranged to be cut off from the roof 2 in order to form an opening 8 in the roof 2 of the elevator car in cases of emergency.

In some cases of emergency, in which the elevator car 1 has stopped at a location in the elevator shaft where the passengers in the car cannot exit the car via the elevator door and the car cannot be moved to any floor level, the passengers must be saved through the roof 2 of the elevator car 1. In such a case, according to the invention, a rescuer or rescuers go onto the roof 2 of the elevator car 1 for example by climbing down from the shaft door of the next floor above. At the top of the roof 2 the rescuer makes an opening 8 to the roof 2 by cutting off the marked portion 4 of the roof 2. The cutting is made for example by sawing.

The marking 3 is made to such an area of the roof 2 where there are no reinforcements or electric cables or other important parts or components at that section of the roof 2. In this embodiment of the invention the marking 3 is a rectangular outline drawing, which is drawn or printed on the roof 2. Alternatively, the marking 3 could be, for example, a paint line, a tape or sticker, a low groove on the upper surface of the roof, or some other suitable marking for this purpose.

In addition, instruction and/or information markings 5a and 5b are made on the roof 2. The markings 5a and 5b are for example prints or stickers. In this embodiment of the invention the first marking 5a is an instruction marking, which contains instruction text for the rescuer how and where to do the cutting. The second marking 5b is an information marking, which mentions, for example, that there is no risk of an electric shock if the cutting is made at the marked portion 4.

FIG. 2 presents a situation of emergency where passengers are trapped in the elevator car 1 and a rescuer is making a rescue opening 8 to the roof 2 of the elevator car 1. The rescuer 6 is cutting the roof 2 with a handsaw or alike along one line of the marking 3. A part already cut is indicated with reference number 7.

FIG. 3 presents a situation where people are being rescued from the elevator car. The rescuer 6 has completed the cutting and removed the portion 4 from the roof 2 and thereby made an opening 8 to the roof 2. The passengers in the elevator car 1 are being rescued through the opening 8. In the situation of the FIG. 3 one passenger 9a has already come out of the elevator car 1 and is standing on the roof 2 while the rescuer 6 is helping another passenger 9b to climb out of the car 1.

The opening 8 is not necessarily used only to get passengers out of the elevator car 1. Instead in some cases, the opening 8 is used just to give passengers aid, such as food and water. In some cases it is unsafe or impossible to rescue passengers via the opening 8 and the passengers must be rescued via elevator door. It might take a long time to move the elevator car 1 to some floor level, in which case it is important to get contact to the passengers.

It is obvious to the person skilled in the art that the invention is not restricted to the examples described above but that it may be varied within the scope of the claims presented below. Thus, for instance the cutting off the portion of the elevator car roof can also be made with some other tool than a handsaw, such as angle grinder or some other tool.

1. An elevator provided with an arrangement for making an opening through the roof of an elevator car, wherein the arrangement comprises a marking on the roof of the elevator car for marking a portion of the roof arranged to be cut off from the roof to form an opening in the roof.

2. The elevator according to claim 1 wherein the marking of the portion of the roof is on an area of the roof of the elevator car that is free from elements that would make cutting off the portion unsafe or slow or otherwise difficult.

3. The elevator according to claim 2, wherein the marking of the portion of the roof is on an area of the roof of the elevator car that is free from reinforcements, electric cables or other important parts or components.

4. The elevator according to claim 1, wherein the arrangement comprises instruction and/or information markings for a person cutting off the portion of the roof.

5. The elevator according to claim 4, wherein the instruction and/or information markings are situated on the roof of the elevator car.

6. The elevator according to claim 1, wherein the portion of the roof is arranged to be cut off by sawing.

7. The elevator according to claim 1, wherein the opening is used as a rescue escape for opening people in the elevator car.

8. The elevator according to claim 1, wherein the opening is used to provide help and/or aid to people in the elevator car.

9. The elevator according to claim 1, wherein the marking is one or more of the following: an outline drawing, a paint line, a tape, a sticker, a groove on the upper surface of the roof, or some other suitable marking for this purpose.

10. The elevator according to claim 1, wherein the portion of the roof is arranged to be cut off by a rescuer.

11. The elevator according to claim 2, wherein the arrangement comprises instruction and/or information markings for a person cutting off the portion of the roof.

12. The elevator according to claim 3, wherein the arrangement comprises instruction and/or information markings for a person cutting off the portion of the roof.

13. The elevator according to claim 2, wherein the portion of the roof is arranged to be cut off by sawing.

14. The elevator according to claim 3, wherein the portion of the roof is arranged to be cut off by sawing.

15. The elevator according to claim 4, wherein the portion of the roof is arranged to be cut off by sawing.

16. The elevator according to claim 5, wherein the portion of the roof is arranged to be cut off by sawing.

17. The elevator according to claim 2, wherein the opening is used as a rescue escape opening for people in the elevator car.

18. The elevator according to claim 3, wherein the opening is used as a rescue escape opening for people in the elevator car.

19. The elevator according to claim 4, wherein the opening is used as a rescue escape opening for people in the elevator car.

20. The elevator according to claim 5, wherein the opening is used as a rescue escape opening for people in the elevator car.
